(19) United States
(12) Patent Application Publication
(10) Pub. No.: US 2025/0375742 A1
(43) Pub. Date: Dec. 11, 2025

(54) FACILITATED TRANSPORT MEMBRANES AND RELATED METHODS

(71) Applicants: Battelle Energy Alliance, LLC, Idaho Falls, ID (US); The University of Toledo, Toledo, OH (US)

(72) Inventors: John R. Klaehn, Idaho Falls, ID (US); Christopher J. Orme, Firth, ID (US); Luis A. Diaz Aldana, Idaho Falls, ID (US); Gary Glenn Lipscomb, II, Perrysburg, OH (US)

(21) Appl. No.: 19/229,511

(22) Filed: Jun. 5, 2025

Related U.S. Application Data
(60) Provisional application No. 63/656,488, filed on Jun. 5, 2024.

(51) Int. Cl. B01D 69/12; B01D 69/02; B01D 69/10; B01D 69/14

(52) U.S. Cl. CPC B01D 69/1216; B01D 69/02; B01D 69/10; B01D 69/148; B01D 2325/38

(57) ABSTRACT

A separation membrane comprises a polymer layer, a metal salt layer adjacent to the polymer layer, a hydrophobic polymer-ceramic layer adjacent to the metal salt layer, and a porous support layer adjacent to the hydrophobic polymer-ceramic layer. A facilitated transport separation membrane and a method for separating components in a feed stream are also disclosed.

### CROSS-REFERENCE TO RELATED APPLICATIONS

This application claims the benefit under 35 U.S.C. § 119 (e) of U.S. Provisional Patent Application Ser. No. 63/656,488, filed Jun. 5, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to separation membranes. In particular, embodiments of the disclosure relate to facilitated transport membranes useful for separating olefins from paraffins.

### BACKGROUND

Olefins, particularly ethylene and propylene, are important chemical feedstocks for many products including plastics and fine chemicals. Olefins may be obtained by hydrocarbon cracking of large hydrocarbons, such as from naphtha or natural gas, to obtain mixtures of smaller alkanes and alkenes. Before use, the olefins are separated from these mixtures. Currently, large scale liquid hydrocarbon crackers are employed which utilize cryogenic distillation to carry out alkene-alkane separations. In the United States, olefin production is mainly confined to large-scale production where conventional steam cracking is dominant (oxidative dehydrogenation). A goal of advanced manufacturing is to use so-called “clean electricity” sources. However, clean electricity sources are intermittent and of a variable nature. Conventional processes, such as steam cracking and cryogenic distillation, are not feasible for use with clean electricity due to the limited scale or point source (small scale) processes of clean electricity generation. Cryogenic distillation, for example, requires high energy input and significant time to achieve the temperatures necessary to carry out the separations, which prevents its use with an intermittent energy source or for associated load leveling applications.

Gas separation membranes are known. However, few, if any, gas separation membrane technologies are considered viable for large scale capacities. Because olefins and the corresponding paraffins are similar in molecular size and condensability, their separation with polymeric membranes is difficult. Polymer membranes do not effectively separate alkenes from alkanes. Facilitated transport membranes (FTMs) employ a carrier (e.g., a facilitator) in the membrane that selectively complexes with one of the components of a feed gas. Polymer membranes for the separation of the olefins and paraffins using silver (Ag(I)) salt facilitators are known. Without a facilitator, most polymer membranes do not effectively separate the olefin-paraffin gases. Silver salt facilitated transport membranes use the ability of silver ions to interact reversibly with olefins by forming silver-olefin complexes. Silver-based polymeric FTMs use a variety of Ag(I) salts that are known to interact with double bonds in the olefins, which enables separation of the olefins over paraffins. To achieve the desired transport properties, the Ag(I) ions are dispersed throughout the polymer membrane in high concentrations, such as greater than 50% by weight. However, the Ag(I) ions are unstable due to reduction-oxidation (redox) pathways, and the Ag(I) (Ag⁺¹) ions are reduced to silver metal (Ag(0), Ag⁰, silver black) by reactive gases (e.g., H₂S) or exposure to light. The chemical reduction to silver metal diminishes the effectiveness of the FTMs. Silver-based FTMs can also suffer from instability, low flux, and decrease in performance over time, which is believed to be due to factors such as the reduction of silver ions to silver metal particles by light or impurities. To date, no olefin membrane-based systems have been implemented at large industrial scales.

### BRIEF SUMMARY

Disclosed is a separation membrane comprising a polymer layer and a metal salt layer adjacent to the polymer layer. A hydrophobic polymer-ceramic layer is adjacent to the metal salt layer and a porous support layer is adjacent to the hydrophobic polymer-ceramic layer.

Also disclosed is a facilitated transport separation membrane comprising a polymer layer comprising one or more of polydimethylsiloxane, polyimide, acrylic, epoxy, polyethylene, polystyrene, polyvinylchloride, polytetrafluorethylene, polyester, and polyurethane and a metal salt layer adjacent to the polymer layer. The metal salt layer comprises a filter impregnated with an aqueous silver salt solution. A hydrophobic polymer-ceramic layer is adjacent to the metal salt layer, the hydrophobic polymer-ceramic layer comprising polydimethylsiloxane and one or more of titanium dioxide and titanium (III) oxide. A porous support layer is adjacent to the hydrophobic polymer-ceramic layer.

Also disclosed is a method for separating components in a feed stream. The method comprises providing a separation membrane comprising a membrane stack assembly having a feed stream side and a permeate side. The membrane stack assembly comprises a polymer layer, a metal salt layer adjacent to the polymer layer, a hydrophobic polymer-ceramic layer adjacent to the metal salt layer, and a porous support layer adjacent to the hydrophobic polymer-ceramic layer. The method includes passing a feed stream comprising one or more olefins and paraffins across the feed stream side of the separation membrane, providing a driving force for transmembrane permeation of the feed stream, and withdrawing from the permeate side a permeate enriched in one or more alkenes relative to the feed stream.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is an illustration showing silver bonding to alkenes.

FIG. 2 is an illustration showing a conventional polymeric membrane with ionic channels through which facilitators travel.

FIG. 3 is an illustration of a facilitated transport membrane in accordance with embodiments of the disclosure.

FIG. 4 is an illustration of a system including the facilitated transport membrane of FIG. 3 in accordance with embodiments of the disclosure.

FIG. 5 is a diagram showing separation acts for ethylene recovery in accordance with embodiments of the disclosure.

FIG. 6 is a graph showing gas permeability of a hydrogen gas feed mixture (y-axis, barrers) versus days of operation (x-axis) for a silver facilitated transport membrane in accordance with embodiments of the disclosure.

FIG. 7 is a graph showing gas permeability of a hydrogen gas feed mixture (y-axis, barrers) versus days of operation (x-axis) and C₂H₄/H₂ selectivity for a silver facilitated transport membrane in accordance with embodiments of the disclosure.

FIG. 8 is a bar graph showing ethylene permeation versus time for a comparative facilitated transport membrane and a facilitated transport membrane in accordance with embodiments of the disclosure.

FIG. 9 is a bar graph showing hydrogen permeation versus time for a comparative facilitated transport membrane and a facilitated transport membrane in accordance with embodiments of the disclosure.

### DETAILED DESCRIPTION

The illustrations presented herein are not actual views of any method, material, cathode, battery, or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any membrane system or membrane component when utilized in a conventional manner. Furthermore, these terms may refer to an orientation of elements of any membrane system or membrane component as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “fluid” means gas, vapor, or liquid. As used herein, the term “gas” means gas or vapor.

As used herein, the term “unsaturated hydrocarbon” means a compound comprised of carbon atoms and hydrogen atoms, with at least one carbon-carbon double bond or one carbon-carbon triple bond. The term “olefin” means a member of the family of unsaturated hydrocarbons with a carbon-carbon double bond of the series CₙH₂ₙ where n is the number of carbon atoms and 2n is the number of hydrogen atoms.

The term “paraffin” means a member of the family of saturated aliphatic hydrocarbons of the series CₙH₂ₙ₊₂ where n is the number of carbon atoms and 2n+2 is the number of hydrogen atoms.

Described is a separation membrane and process for separating components from a stream (e.g., a gas stream). The separation membrane comprises a polymer layer; a metal salt layer (e.g., a filter layer impregnated with a metal salt solution, e.g., an aqueous metal salt solution) adjacent to the polymer layer; a hydrophobic polymer-ceramic layer (e.g., a hydrophobic polymer-reduced titanium dioxide layer) adjacent to the metal salt layer; and a porous support layer adjacent to the hydrophobic polymer/ceramic layer. The separation membrane and process may be utilized for separation of components in the gas stream. The composition of the gas stream may vary widely. The separation membrane and process may also be useful for separation of unsaturated hydrocarbons from liquid mixtures. In embodiments, the separation membrane is utilized for separation of olefins (e.g., alkenes) from paraffins (e.g., alkanes). However, the separation membrane may be utilized for other applications including, but not limited to, separation of aromatic compounds from saturated hydrocarbons, such as separation of benzene from cyclohexane.

The separation membrane and process are suitable for use with clean electricity sources and may provide point-source or small scale generation (that is, separation) of a desired component from the gas stream such as point-source or small scale separation of ethylene from a gas stream comprising one or more of ethane and carbon dioxide. The separation membrane and process may be employed with minimal operational ramp up time as compared to conventional separation processes. In use and operation, the separation membrane may be exposed to the gas stream to achieve a steady state. A separation system or process that utilizes the membrane may then be turned off and back on again and will resume the steady state. The separation membrane and process may also be scaled up for large-scale production applications.

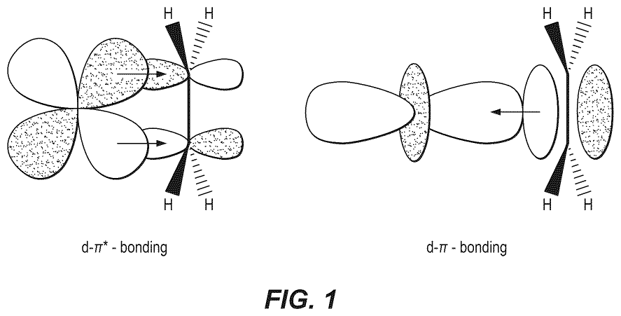

Silver (I) embedded facilitated transport membranes (FTMs) may provide effective gas separations and permeations such as separations of olefins (e.g., ethylene) from a feed stream (e.g., the gas stream) comprising one or more olefins and paraffins. FIG. 1 shows silver d-π* and d-π bonding to ethylene. Without wishing to be bound by theory, it is believed that silver's open d-orbitals are responsible for chelating olefins in a dynamic fashion wherein the olefins are not tightly bound to the silver. The silver ions are believed to exhibit a sufficiently strong association to bind to ethylene while simultaneously exhibiting a sufficiently loose association to release the ethylene. As a result, olefin facilitation may occur where chelated alkenes are transported preferentially from one Ag⁺ (atom or colloid) to the next. It is believed that this phenomenon is more advantageous in a solution state (freely mobile) than as a solid state (Ag⁺ affixed and/or bound in the polymer membrane).

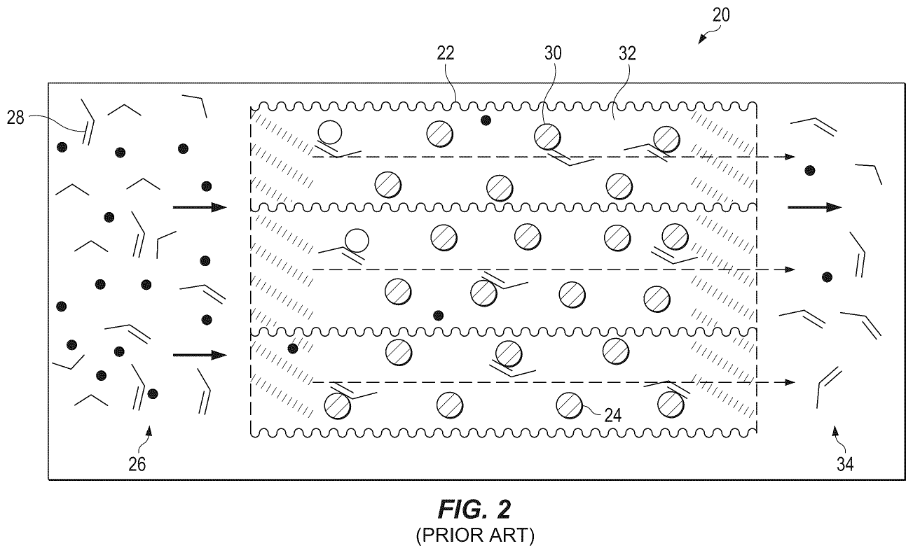

Referring to FIG. 2, a conventional separation membrane 20 comprising a polymeric membrane 22 having silver (Ag⁺) facilitators 24 (e.g., silver ions) is shown. In operation, a feed stream (e.g., feed gas) 26 comprising olefins 28 is supplied to a feed stream side of the separation membrane 20. Olefin facilitation may be viewed as a so-called “hopping” mechanism where nearby Ag⁺ atoms 24 bind to an olefin 28, forming a bonded Ag⁺-olefin 30 in the polymeric membrane 22. The hopping mechanism may use a high degree of flexibility in a polymer membrane and/or accessible Ag⁺ ions (high concentrations (e.g., about 70 wt % by polymer)/potentially mobile ions), so that the olefin 28 will be transported from one Ag⁺ ion 24 to the next by forming so-called “ionic channels” 32. The separated olefins exit the polymeric membrane 22 as a permeate 34 (e.g., a permeate enriched with olefin as compared to feed gas 26). It is believed that due to the condensable nature of olefin gases with Ag⁺ in the polymer membrane, polymer flexibility may be achieved by swelling the membrane during olefin transport and/or having a low glass transition (Tg), rubbery polymer membrane. If there are not enough accessible silver ions in the membrane and/or the polymer membrane hinders Ag⁺/olefin transport, then olefin facilitation will not ensue. For instance, olefin transport may be difficult through rigid, glassy polymer membranes, such as MATRIMID® 5218 (thermoplastic polyimide); therefore, greater quantities of Ag⁺ salts are needed to create suitable conditions for olefin facilitated transport in these types of membranes.

Gas permeability through a polymeric membrane may be represented as an equation P=D·S wherein P is permeability, D is diffusivity, and S is solubility. Thus, permeability P is a product of overall gas transport through the membrane. Diffusivity (D) is the pressure-induced transport of gases through the polymer matrix. Gas molecules follow the path of least resistance, passing through channels and void space (molecular sieving). Solubility(S) comprises the interactions between the gases and the polymer matrix (sorption). The gas molecules interact with the polymer structure (solution-diffusion). Solubility may be considered the dominant mechanism of gas permeability.

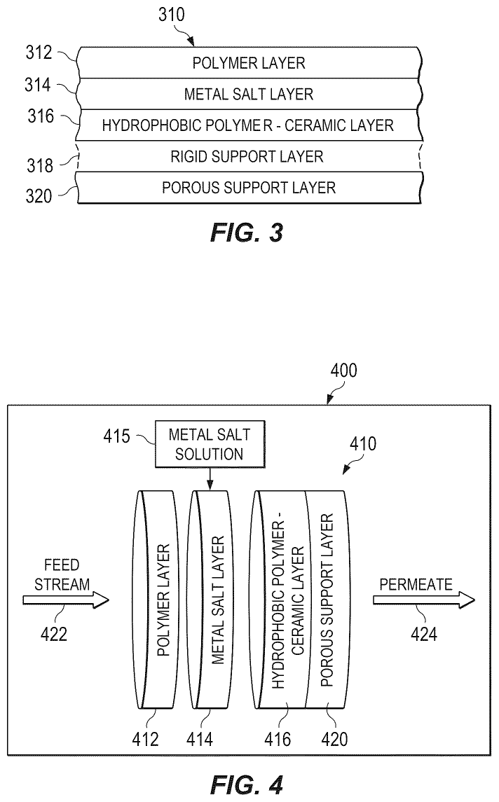

The separation membrane of embodiments of the disclosure comprises a metal salt embedded facilitated transport membrane providing effective gas separations and permeation. Conventional facilitated transport membranes enable separations of binary mixtures of gases. The facilitated transport membrane in accordance with embodiments of the disclosure may be used for separating components in a feed stream comprising multiple gas combinations or gas mixtures comprising many (e.g., several) different gases. In embodiments of the disclosure, the facilitated transport membrane is used for separating olefins (e.g., ethylene) from paraffins in a feed stream comprising one or more olefins and paraffins. A facilitated transport membrane 310 in accordance with embodiments of the disclosure is illustrated in FIG. 3. FIG. 4 illustrates the membrane 310 of FIG. 3 in a system 400. The facilitated transport membrane 310 is a multi-layered composite membrane. The layers may be of any shape or configuration. For example, the layers may comprise disks or circles of any desired size (e.g., 150 millimeter disks). The layers may be connected, such as with an O ring around the center, with the optional application of pressure. An O ring may be utilized, as known in the art, to seal a joining of the one or more layers. The O ring may seal the one or more layers such that no air, gas, or liquid may pass. The O ring may be fitted onto the layers and configured to resist pressure. The layers may contact one another or there may be separation between one or more of the layers (e.g., the layers may be spaced apart). The facilitated transport membrane 310 may be formed as a flat sheet, which is then rolled into a spiral-wound module, for example, to provide a high surface area membrane in a small package.

The facilitated transport membrane 310 includes a polymer layer 312, a metal salt layer 314, a hydrophobic polymer-ceramic layer 316, a rigid support layer 318, and a porous support layer 320. In operation, the polymer layer 312 is on the feed stream (e.g., input) side (shown in FIG. 4) of the facilitated transport membrane 310. The polymer layer 312 may ameliorate the effects of gas pressure on the system. The polymer layer 312 may comprise a silicone polymer, such as polydimethylsiloxane, a polyimide, a polyamide, or a polyester. In embodiments of the discourse, the polymer layer 312 is polydimethylsiloxane. The thickness of the polymer layer 312 is not limited and may be selected depending upon the volume of the feed stream, the components of the feed stream, and the overall size of the system. In embodiments, the polymer layer 312 exhibits a thickness of from about 25 micrometers to about 300 micrometers. The size and configuration of the polymer layer 312 is not limited and also may be selected depending upon the volume of the feed stream, the components of the feed stream, and the overall size of the system. By way of example, the polymer layer 312 may exhibit a circular or disk shape having a diameter from about 100 millimeters to about 200 millimeters, or from about 125 millimeters to about 1775 millimeters, or about 150 millimeters.

Metal salt layer 314 of the facilitated transport membrane 310 comprises a metal salt layer 314 (e.g., a filter impregnated with a metal salt solution). The metal salt remains in solution (e.g., aqueous solution) throughout the acts of the method. The metal salt layer 314 is adjacent to the polymer layer 312. The filter may comprise any material capable of containing the metal salt solution. In embodiments, the filter is a glass filter (e.g., a glass fiber filter). The thickness of the metal salt layer 314 is not limited and may be selected depending upon the volume of the feed stream and the overall size of the system. In embodiments, the metal salt layer 314 exhibits a thickness of from about 0.5 micrometers to about 10 micrometers, or from about 1 micrometer to about 5 micrometers. The size and configuration of the metal salt layer 314 comprising a filter impregnated with a metal salt solution is not limited and also may be selected depending upon the volume of the feed stream, the components of the feed stream, and the overall size of the system. By way of example, the metal salt layer 314 comprising a filter impregnated with a metal salt solution may exhibit a circular or disk shape having a diameter from about 100 millimeters to about 200 millimeters, or from about 125 millimeters to about 175 millimeters, or about 150 millimeters.

The metal salt layer 314 (e.g., the filter impregnated with a metal salt solution) is wetted or impregnated with a metal salt solution. The metal salt solution may comprise an ionic metal salt in a solvent, such as water or an organic solvent. For example, the solvent may comprise “NANOPURE™ Water” (water purified using a BARNSTEAD™/THERMOLYNE™ NANOPURE™ lab water system). The NANOPURE™ water may be purged with argon. In embodiments of the disclosure, the water is purged (e.g., purged with argon) to reduce or eliminate air oxidation). The metal salt solution may be prepared by dissolving the metal salt in the solvent in a suitable container. Dissolution of the metal salt may be conducted while minimizing light exposure, such as by covering the container with aluminum foil while dissolving the metal salt in the solvent. The metal salt solution may be considered a room temperature (e.g., about 20° C. to about 25° C.) ionic liquid.

The ionic metal salt comprises a metal cation and a salt anion. The metal of the metal salt may comprise one or more of copper, silver, gold, cadmium, mercury, bismuth, titanium, tin, and lead. In embodiments, the metal is silver or copper. In certain embodiments, the metal is silver. The salt anion may comprise one or more of iodide (I⁻), bisulfide (SH⁻), cyanide (CN⁻), thiocyanide (SCN⁻), nitrate (NO₃⁻), nitride (N₃⁻), tetrafluoroborate (BF₄⁻), tetraphenylborate (B(C₆H₅)₄⁻), triflate (CF₃SO₃⁻), bistriflimide ((CF₃SO₂)₂N⁻), and sulfide (S₂⁻). In embodiments, the salt anion is cyanide (CN⁻), tetrafluoroborate (BF₄⁻), or tetraphenylborate (B(C₆H₅)₄⁻). In certain embodiments, the salt anion is tetrafluoroborate (BF₄⁻).

The concentration of the ionic metal salt in solution is not limited. The ionic metal salt solution may be provided at a molar concentration of from about 1 mole ionic metal salt per 1 liter of solution to about 5 moles ionic metal salt per 1 liter of solution, or about 1 mole ionic metal salt per 2 liters of solution. By way of example only, an aqueous silver salt solution may comprise a 1.3M AgBF₄ solution or a 1.5M AgNO₃ solution. The amount of metal salt solution provided to the filter may depend on factors including the size of the filter and the composition of the feed stream. By way of example only, a glass fiber filter disk of from about 1 micrometer to about 5 micrometers in thickness and having a diameter of about 150 millimeters may be impregnated with from about 0.5 milliliters to about 5 milliliters of a 1.3M AgBF₄ solution. The metal salt solution (e.g., silver salt solution) may be prepared in advance and stored for future membrane preparation. Without wishing to be bound by theory, it is believed that the silver salt organizes itself with water around it so that the silver is protected from hydrogen reduction by the water. That is, the aqueous silver salt solution inhibits or prevents altogether hydrogen reduction of silver, improving the longevity of the membrane. Thus, water may improve one or more of membrane permeability, selectivity, and longevity. Oxygen may also cause formation of so-called silver black (e.g., reduced Ag⁺ ions forming Ag metal). It has been discovered that preparing the silver salt solution and covering the prepared silver salt solution with an inert gas, such as argon, enables formation of a silver salt solution that can be stored for a year or more without formation of silver black.

Hydrophobic polymer-ceramic layer 316 (e.g., porous ceramic layer) comprises a hydrophobic polymer and a ceramic and is adjacent to the metal salt layer 314. That is, hydrophobic polymer-ceramic layer 316 is provided between metal salt layer 314 and porous support layer 320. The hydrophobic polymer-ceramic layer may comprise a hydrophobic polymer blended (e.g., combined, mixed) with a ceramic. The hydrophobic polymer and ceramic may be distributed in the hydrophobic polymer-ceramic layer 316 to form a porous membrane. The hydrophobic polymer of hydrophobic polymer-ceramic layer 316 may comprise any hydrophobic polymer that is not active or binding to the metal ion of the metal salt solution. In other words, the hydrophobic polymer does not react with the metal ion of the metal salt solution. The hydrophobic polymer may comprise one or more of an acrylic, an epoxy, a polyethylene, a polystyrene, polyvinylchloride, polytetrafluorethylene, polydimethylsiloxane, a polyester, and a polyurethane. In embodiments of the disclosure, the hydrophobic polymer is polydimethylsiloxane. When water is in the form of a liquid, polydimethylsiloxane is considered a hydrophobic polymer. When water is in the form of a gas or vapor, polydimethylsiloxane does not hinder the water vapor but rather allows the water vapor to pass through. This enables a high water vapor throughput because the water vapor is permeable through the polydimethylsiloxane and does not react with the polydimethylsiloxane. While not wishing to be bound by theory, it is believed that a small amount of liquid water is present in one or more of the water vapor and the feed stream and that one or both of the water vapor and the small amount of liquid water enhance the ability of the silver salt to move around in the metal salt layer 314. This is believed to contribute to the relatively high permeance of ethylene achieved by the facilitated transport membrane 310.

The ceramic of hydrophobic polymer-ceramic layer 316 may comprise an oxide ceramic, a metal organic framework (MOF), or a molecular sieve. A MOF is a potentially porous extended structure made from metal ions and organic linkers. MOFs are composed of two main components: an inorganic metal cluster (often referred to as a secondary-building unit or SBU) and an organic molecule called a linker. The choice of metal and linker dictates the structure and hence properties of the MOF. The molecular sieve may comprise one or more of an aluminosilicate zeolite having a Si/Al molar ratio of less than 2, an activated charcoal, and a silica gel. By way of example only, the molecular sieve may be a crystalline metal aluminosilicate having a three-dimensional interconnecting network of silica and alumina tetrahedra. The oxide ceramic may comprise one or more of aluminum oxide (Al₂O₃), zirconium dioxide (ZrO₂), titanium dioxide (TiO₂), reduced titanium dioxide (e.g., titanium (III) oxide (Ti₂O₃)), magnesium oxide (MgO), and silicon dioxide (SiO₂). In embodiments of the disclosure, the oxide ceramic comprises one or more of titanium dioxide (TiO₂), titanium (III) oxide (Ti₂O₃), and blue-colored titanium dioxide. Ag(I) ions are unstable due to reduction-oxidation (redox) pathways, and the Ag(I) (Ag⁺¹) ions may be reduced to silver metal (Ag(0), Ag⁰, silver black) by reactive gases (e.g., H₂S), exposure to light, and exposure to water and organics. The chemical reduction to silver metal may diminish the effectiveness of the facilitated transport membrane.

In embodiments of the disclosure, the oxide ceramic comprises titania (e.g., TiO₂, Ti₂O₃). In a specific embodiment, the oxide ceramic comprises titanium (III) oxide (Ti₂O₃) (also known as reduced titania or black titania). Without wishing to be bound by theory, titanium (III) oxide (e.g., reduced titania), appears to inhibit the reduction of silver salts in solution. The titanium (III) oxide provides protection of the silver salt improving properties such as the stability of the silver salt. Thus, the facilitated transport membrane 310 in accordance with embodiments of the disclosure comprising titanium (III) oxide may exhibit a longer life cycle than conventional membranes.

The hydrophobic polymer-ceramic layer 316 comprising a hydrophobic polymer and a ceramic may be prepared by combining the hydrophobic polymer and the ceramic, such as by mixing. By way of example only, a prepolymer of polydimethylsiloxane may be blended with titania (e.g., Ti₂O₃, black titania) and treated (e.g., heated) to polymerize the prepolymer to form a layer comprising polydimethylsiloxane and titania. The hydrophobic polymer-ceramic layer 316 may be provided onto a porous support layer 320 such as by knife casting, dip coating, or other means known in the art. The hydrophobic polymer-ceramic layer 316 may be provided at a suitable thickness selected according to the system and the feed stream. By way of example only, the hydrophobic polymer-ceramic layer 316 comprising a hydrophobic polymer and a ceramic exhibits a thickness of from about 25 to about 300 micrometers. The size and configuration of the hydrophobic polymer-ceramic layer 316 comprising a hydrophobic polymer and a ceramic is not limited and also may be selected depending upon the volume of the feed stream, the components of the feed stream, and the overall size of the system. By way of example, the hydrophobic polymer-ceramic layer 316 comprising a hydrophobic polymer and a ceramic may exhibit a circular or disk shape having a diameter from about 100 millimeters to about 200 millimeters, or from about 125 millimeters to about 175 millimeters, or about 150 millimeters.

The porous support layer 320 may be any suitable material that provides support to the ceramic layer 316. The porous support layer 320 may comprise one or more of polyether sulfone, polyacrylonitrile, polyvinylidene fluoride, polyamide (e.g., nylon, 6,6, polyhexamethylene adipamide), polypropylene, polyethylene, polyester, polyimide, polyaramid, among others. In embodiments, the porous support layer 320 is a polyether sulfone (e.g., SYNDER® film). The porous support layer 320 may be provided at a suitable thickness selected according to the system and the feed stream. In embodiments, the porous support layer 320 may exhibit a thickness of from about 0.5 micrometers to about 10 micrometers or from about 0.5 micrometers to about 3 micrometers. By way of example only, the porous support layer 320 may be a SYNDER® film exhibiting a thickness of about 0.1 micrometer. The porous support layer 320 may be of any size or configuration. By way of example, the porous support layer 320 may exhibit a circular or disk shape having a diameter from about 100 millimeters to about 200 millimeters, or from about 125 millimeters to about 175 millimeters, or about 150 millimeters. In embodiments of the disclosure, the metal salt layer 314 comprising a filter impregnated with a metal salt solution has complete coverage (e.g., substantially completely covers) of the hydrophobic polymer and ceramic layer 316 and the porous support layer 320. In other words, the layers may exhibit a substantially similar size (e.g., diameter). By way of example only, the metal salt layer 314 (e.g., a silver salt solution impregnated layer) exhibits complete coverage over a polydimethylsiloxane and titanium dioxide hydrophobic polymer-ceramic layer 316 and a SYNDER® film layer 320.

Optionally, a rigid support layer (e.g., stainless steel layer, nylon, polypropylene) 318 may be provided between the hydrophobic polymer-ceramic layer 316 and the porous support layer 320. If a rigid support layer 318 is included, the hydrophobic polymer-ceramic layer 316 may be provided (e.g., coated) onto the rigid support layer 318. The rigid support layer (e.g., stainless steel layer) 318 may be provided at a suitable thickness. The rigid support layer 318 may be one of the materials described above for the porous support layer 320. The rigid support layer 318 may be selected to enable a suitable gas flow (e.g., a non-restrictive gas flow) through the FTM 310. By way of example only, the rigid support layer 318 may exhibit a thickness of from about 0.0001 to about 10 millimeters. The size and configuration of the rigid support layer 318 is not limited. By way of example, the rigid support layer (e.g., stainless steel layer) 318 may exhibit a circular or disk shape having a diameter from about 100 millimeters to about 200 millimeters, or from about 125 millimeters to about 175 millimeters, or about 150 millimeters. One or both of the porous support layer 320 and rigid support layer 318 are selected to provide the membrane with rigid support sufficient to withstand the pressure on the front side of the membrane. Alternately, if the porous support layer 320 provides sufficient support such that the membrane is a so-called “self-supported” membrane (e.g., nylon mesh, polypropylene mesh, wire (e.g., non-corroding wire) mesh), the rigid support layer 318 may not be employed. The rigid support layer 318 is, therefore, optional if the FTM 310 can operate (e.g., function effectively) with the pressure of the gas.

FIG. 4 shows a system 400 including a facilitated transport membrane 410 in accordance with embodiments of the disclosure. While FIG. 4 shows the membrane 410 components spaced apart for easier visualization, in operation, the membrane components will touch one another. The facilitated transport membrane 410 may include a polymer layer 412 (e.g., a polydimethylsiloxane polymer layer). A metal salt layer 414 impregnated with a silver salt solution 415 (e.g., glass fiber filter impregnated with a silver salt solution) may be adjacent the polydimethylsiloxane polymer layer 412. A hydrophobic polymer-ceramic layer 416 (e.g., a polydimethylsiloxane and titanium dioxide layer) may be adjacent metal salt layer 414. A porous support layer 420 (e.g., a SYNDER® film support layer) may be adjacent the hydrophobic polymer-ceramic layer 416. A rigid support layer (e.g., a stainless steel layer) (not shown) may be provided between the hydrophobic polymer-ceramic layer 416 and the porous support layer 420.

The system 400 may be used in a process for separating components of a feed stream and comprises providing the separation membrane (e.g., facilitated transport membrane 410) including a membrane stack assembly having a feed stream side configured to input a feed stream 422 (e.g., a mixed gas comprising ethylene and one or more other gaseous components). The feed stream may comprise one or more gases such as one or more of nitrogen, carbon dioxide, hydrogen gas, carbon monoxide, methane, ethylene, ethane, and helium. The feed stream may comprise a gas stream formed from electroreduction of CO₂ to ethylene. By way of example only, the feed stream 422 may include about 2 volume percent each of nitrogen, carbon monoxide, carbon dioxide, ethylene, ethane, in a balance of helium. The feed stream 422 may optionally comprise a humidified feed stream. A driving force (not shown) may be provided for transmembrane permeation of the feed stream 422. Providing the driving force may be accomplished by several methods as known in the art. The driving force may comprise providing a partial pressure on the feed stream side that is higher than the partial pressure on the product (e.g., the permeate) side of the membrane. The feed stream side may be pressurized to increase the partial pressure of alkene on the feed stream side. Another method of achieving the driving force comprises sweeping the second side (e.g., the permeate side) with an inert gas, such as nitrogen, to lower the partial pressure of the alkene on the permeate side. Still another method of achieving the driving force comprises reducing the pressure of the permeate side by vacuum pump to lower the partial pressure of the alkene on the second side. The feed stream 422 passes through the facilitated transport membrane 410 and exits (e.g., is withdrawn from) the permeate side as a permeate 424, which is enriched in one or more components (e.g., an enriched ethylene permeate) as compared with the feed stream 422. The system 400 may be used to chemically reduce CO₂ in the feed stream 422 to ethylene in a reduction process, with the permeate 424 containing a relatively greater amount of ethylene than the feed stream 422.

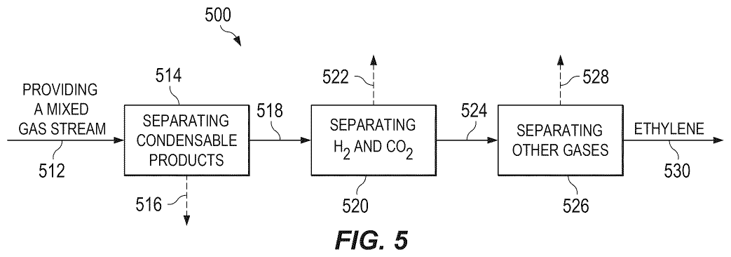

The facilitated transport membrane 310, 410 and process may be employed in an ethylene production process for processing various gas streams such as gas streams obtained via electrocatalytic conversion. Turning to FIG. 5, a schematic diagram 500 shows acts for employing the facilitated transport membrane 310, 410 in a process including providing a mixed gas stream 512 (e.g., an electrolyzer output mixed stream) comprising a combination of components (e.g., a gas mixture) including a mixture of two or more of hydrogen gas, carbon dioxide, carbon monoxide, methane, ethane, and ethylene. Separation act 514 includes separating condensable products (e.g., moisture and acids) from the mixed gas stream 512 to remove a stream 516 of condensable products (e.g., moisture and acids) and produce a stream 518 that is substantially free of the condensable products. Separation act 514 may be conducted, for example, using a chiller. Separation act 520 includes treating stream 518, such as bypassing stream 518 through a molecular sieving membrane, to separate (e.g., remove) hydrogen gas and carbon dioxide and to remove a hydrogen gas 522 and carbon dioxide stream to produce feed stream 524. Separation act 526 includes passing feed stream 524 through a facilitated transport membrane to separate remaining components 528 (e.g., other gases such as methane, carbon monoxide, ethane) from feed stream 524 to produce a permeate 530 (e.g., a permeate comprising an ethylene enriched stream). The permeate 530 may include the ethylene in an amount of about 90 volume percent or greater than about 90 volume percent.

The following examples serve to explain embodiments of the disclosure in more detail. These examples are not to be construed as being exhaustive or exclusive as to the scope of the disclosure.

### EXAMPLES

An electrolyzer product extraction and separation system analysis was performed. A gas mixture (e.g., an electrolyzer gas feed stream) comprising ethylene, methane, carbon monoxide (CO), and ethane was passed through a silver facilitated transport membrane and analyzed for ethylene separation. The feed stream comprised a 1:1 ethylene/methane-ethane (and optionally other gases) composition. The silver facilitated transport membrane had a surface area of from 5 cm² to about 20 cm².

Mixed-gas permeability tests were also performed on a simulated ethylene stream containing 2 vol % each of nitrogen (N₂), carbon monoxide (CO), carbon dioxide (CO₂), ethylene (C₂H₄), ethane (C₂H₆) in a balance of helium (He). Mixed-gas experiments with so-called “problem gases” (e.g., CO₂, CO, CH₄ and water) have not been shown in literature with a silver facilitated transport membrane. Hydrogen and water vapor are two components that may also be removed. Table 1 shows mixed gas data on various polymer membranes and a polydimethylsiloxane silver facilitated transport membrane (PDMS/Ag FTM) in accordance with embodiments of the disclosure using a simulated gas feed stream comprising 2 vol. % each of nitrogen (N₂), carbon monoxide (CO), carbon dioxide (CO₂), ethylene (C₂H₄), ethane (C₂H₆) in a balance of helium (He). Table 1 shows the results of several polymer membranes tested against the simulated gas mixture at low percentages. Table 1 shows that most polymer membranes are not selective for ethylene over ethane, except TPX 80. TPX 80 has a selectivity ratio of 2.1 (ethylene/ethane) but low gas permeabilities compared to polydimethylsiloxane (PDMS). For ethylene recovery, PDMS was selected due to its high gas permeabilities (orders of magnitude higher) compared to the other polymers (glassy polymers). It was surprisingly found that the polydimethyl siloxane/silver facilitated transport membrane (PDMS/Ag FTM) in accordance with embodiments of the disclosure exhibited a selectivity ratio of 11.4 for ethylene over ethane over a 24-hour period in the mixed-gas feed stream. The membrane performance did not diminish while being exposed to these gases.

The gas permeabilities between PDMS and PDMS/Ag FTM were compared. N₂, CO and CO₂ have inhibited gas flows, like ethane. It was not expected that N₂ was in the electrolyzer feed stream, but it can have some impact if N₂ is used as a carrier gas. Also, CO₂ should be reduced (nearly removed) prior to ethylene recovery step. Overall, the facilitated transported membrane in accordance with embodiments of the disclosure enriched ethylene over the other gases.

TABLE 1

| | Permeability (Barrers¹) | | | | | Selectivity Ratio |
|---|---|---|---|---|---|---|
| Polymer Membrane | N₂ | CO | CO₂ | Ethylene | Ethane | Ethylene/Ethane |
| PDMS | 362.3 | 385.0 | 2323.0 | 1841.0 | 2016.2 | 0.9 |
| PDMS/Ag FTM | 295.3 | 147.2 | 1313.3 | 2461.8 | 215.9 | 11.4 |
| TPX 80 (Polymethylpentene) | 6.3 | 5.2 | 61.4 | 5.6 | 2.6 | 2.1 |
| Udel (Polysulfone) | 0.127 | 0.119 | 5.473 | 0.099 | 0.094 | 1.1 |
| Kapton-HN (polyimide) | 0.045 | 0.042 | 0.196 | 0.035 | 0.034 | 1.1 |

¹Barrer: (cm³*cm/cm²*sec*cmHg)*10⁻¹⁰

A PDMS silver (Ag) FTM in accordance with embodiments of the disclosure was prepared and tested with results shown in Table 2. PDMS Ag FTMs including different amounts of PDMS and silver tetrafluoroborate (AgBF₄) were tested. Several mixed-gas permeability tests were done on a simulated ethylene stream containing 2 vol % each of nitrogen (N₂), carbon monoxide (CO), carbon dioxide (CO₂), ethylene (C₂H₄), ethane (C₂H₆) in a balance of helium (He), and another mixed-gas containing 10 vol % each of CO₂, CH₄, and C₂H₄ in a balance of helium (He), and 50/50 vol % C₂H₄/C₂H₆. In literature, problematic gases (e.g., CO₂, CO, CH₄ and water) are not typically combined with target gases (C₂H₄). It was found that water/water vapor does not adversely affect the ethylene transport with the PDMS Ag FTM. Hydrogen may be removed (FIG. 5), but may be included for testing after establishing exposure limits of the PDMS Ag FTM with mixed gas streams.

TABLE 2

| | | | | | | | Selectivity | Selectivity | Selectivity |
|---|---|---|---|---|---|---|---|---|---|
| | | | | | | | Ratio | Ratio | Ratio |
| Polymer | Permeability (Barrers^{a}) | | | | | | C₂H₄/ | C₂H₄/ | C₂H₄/ |
| Membrane | N₂ | CO | CO₂ | CH₄ | C₂H₆ | C₂H₄ | C₂H₆ | CO₂ | CO |
| PDMS | 362 | 385 | 2323 | 950 | 2016 | 1841 | 0.9 | 0.8 | 4.8 |
| (Parent | | | | | | | | | |
| Polymer) | | | | | | | | | |
| PDMS/Ag | 295 | 147 | 1313 | — | 216 | 2462 | 11.4 | 1.9 | 16.7 |
| FTM (2 | | | | | | | | | |
| vol % each)^{b} | | | | | | | | | |
| For 30 days | | | | | | | | | |
| PDMS/Ag | — | — | 536 | 268 | — | 1835 | 7^{c} | 3.4 | — |
| FTM (10 | | | | | | | | | |
| vol % each)^{b} | | | | | | | | | |
| For 30 days | | | | | | | | | |
| PDMS/Ag | — | — | — | — | 25.3 | 1885 | 74 | — | — |
| FTM (50 | | | | | | | | | |
| vol % each)^{b} | | | | | | | | | |
| For 200 | | | | | | | | | |
| hours | | | | | | | | | |

^{a}Barrer: (cm³*cm/cm²*sec*cmHg)*10⁻¹⁰
^{b}Remaining balance with Helium
^{c}Selectivity ratio of C₂H₄/CH₄ (ethylene/methane)

As shown in Table 2, the Ag FTM in accordance with embodiments of the disclosure exhibited excellent gas permeabilities for ethylene compared to the comparative parent PDMS polymer lacking silver. In addition, exposure of problematic gases (CO₂, CO, CH₄, and water) did not significantly change the ethylene separations. Even after 30 days, the PDMS/Ag FTMs showed a selectivity ratio of about 11 for ethylene over ethane and about 7 for methane with mixed-gas feed streams (2 vol %, 10 vol % and 50 vol %). The 50/50 mix achieved a high selectivity of 74 over 200 hours. Overall, these selectivities are close to 90% recovery of ethylene from ethane, which meets a desired target separation not shown with previous membranes. The results illustrate that the Ag FTM can be utilized with an electrolyzer product gas stream.

Gas permeability measurements with hydrogen (H₂) present in the mixed gas simulated gas feed were performed with a PDMS silver (Ag⁺) facilitated transport membrane (FTM) in accordance with embodiments of the disclosure. An evaluation of how H₂ in the electrolyzer gas stream from the electrolyzer affects the permeability and selectivity of ethylene from alkanes was performed. H₂ is a reductive gas that will electrochemically reduce the active Ag⁺ facilitator. However, our experiments with a 24 to 48 hour exposure time did not adversely affect the Ag FTM selectivity or permeability. The mixed-gas permeability tests were primarily done on a simulated ethylene stream containing 10 vol % of carbon dioxide (CO₂), methane (CH₄), and ethylene (C₂H₄) in a balance of helium (He).

Table 3 shows separation results for gas mixtures comprising ethylene before and after H₂ exposure. The results in Table 3 illustrate the PDMS Ag FTM effectively separated ethylene at 2 vol %, 10 vol % and 50 vol % ethylene in a gas mixture for weeks.

TABLE 3

| | | | | | | | Selectivity | Selectivity | Selectivity |
|---|---|---|---|---|---|---|---|---|---|
| | | | | | | | Ratio | Ratio | Ratio |
| Polymer | Permeability (Barrers^{a}) | | | | | | C₂H₄/ | C₂H₄/ | C₂H₄/ |
| Membrane | N₂ | CO | CO₂ | CH₄ | C₂H₆ | C₂H₄ | C₂H₆ | CO₂ | CO |
| PDMS | 362 | 385 | 2323 | 950 | 2016 | 1841 | 0.9 | 0.8 | 4.8 |
| (Parent | | | | | | | | | |
| Polymer) | | | | | | | | | |
| PDMS/Ag | — | — | 38 | — | 11 | 219 | 20 | 5.8 | — |
| FTM (2 | | | | | | | | | |
| vol % each)^{b} | | | | | | | | | |
| Before H₂ | | | | | | | | | |
| Exposure | | | | | | | | | |
| PDMS/Ag | — | — | 29 | — | 3.1 | 182 | 60 | 6.3 | — |
| FTM (2 | | | | | | | | | |
| vol % each)^{b} | | | | | | | | | |
| After 24 | | | | | | | | | |
| hours of H₂ | | | | | | | | | |
| Exposure | | | | | | | | | |
| PDMS/Ag | — | — | 30 | — | 3.3 | 157 | 48 | 5.2 | — |
| FTM (2 | | | | | | | | | |
| vol % each)^{b} | | | | | | | | | |
| After 48 | | | | | | | | | |
| hours of H₂ | | | | | | | | | |
| Exposure | | | | | | | | | |

The PDMS Ag FTM showed little to no change in ethylene production after 48 hours of hydrogen exposure. As a result, the membrane had the ability to be directly exposed to the electrolyzer feed stream and produce ethylene without the necessity of performing preliminary separations, such as illustrated in FIG. 5, over a short duration (24 hours).

The PDMS Ag FTM was able to separate and selectively capture ethylene from a gas mixture (including CO₂ and CO) with ethylene selectivities of 90% over ethane. Nonetheless, H₂ is a component of this gas feed stream and is preferably substantially removed from the feed gas mixture before ethylene separation. H₂ is a major component in the electrolyzer product gas stream. H₂ is not commonly tested with ethylene production for FTMs, but H₂ poses a detrimental problem in silver reduction and loss of ethylene separations during electrolyzer gas production. The PDMS Ag FTMs in accordance with embodiments of the disclosure exhibited excellent gas permeabilities (>100 GPU) and selectivity (7-10 [ethylene/ethane]) for ethylene compared to the parent PDMS polymer. In addition, exposure of potential problematic gases (CO₂, CO, CH₄, and water) did not significantly diminish these ethylene separations over 30 days of exposure. These results show the PDMS Ag FTMs effectively separated ethylene at different concentrations of 2 vol %, 10 vol % and 50 vol % ethylene in a gas mixture for weeks.

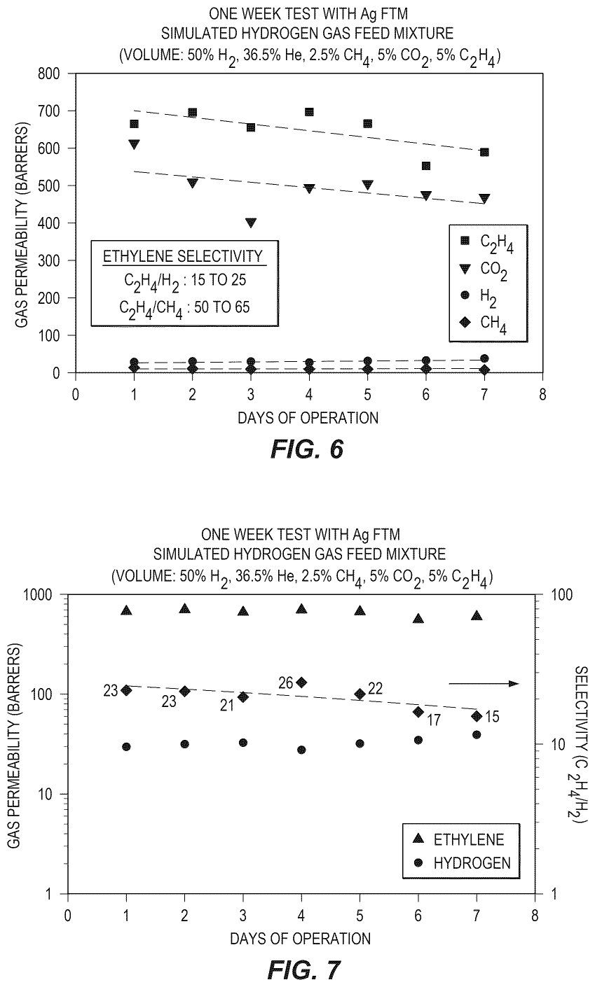

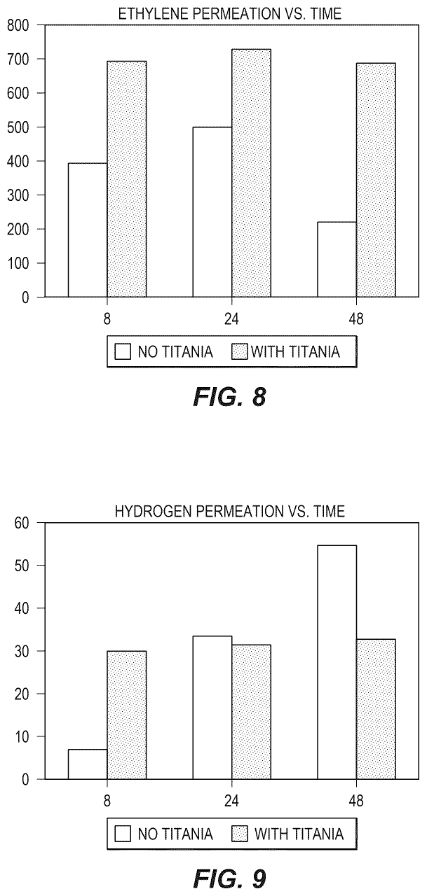

A mixed gas permeation test was performed on a PDMS Ag FTM in accordance with embodiments of the disclosure comprising exposing the PDMS Ag FTM simultaneously to H₂ in a gas mixture while separating ethylene. The gas mixture comprising 50 volume percent (vol %) H₂, 36.5 vol % He, 2.5 vol % CH₄, 5 vol % CO₂, 5 vol % C₂H₄ was applied to the PDMS AG FTM. FIG. 6 and FIG. 7 show results for the PDMS Ag FTM gas permeation with the hydrogen containing gas mixture with ethylene over one week. FIG. 6 shows results for the PDMS Ag FTM gas permeation of a gas mixture comprising ethylene, CO₂, H₂, and CH₄. FIG. 7 shows results for the PDMS Ag FTM gas permeation of ethylene and H₂ gas and ethylene/H₂ gas selectivity ratio. Referring to FIG. 8 and FIG. 9, gas permeability and selectivity ratios of ethylene showed marginal losses after seven days with a 50 vol % of H₂. The results show that the PDMS Ag FTM can survive a continuous high concentration H₂ atmosphere, while achieving selectivity ratios of 50-65 to ethylene/CH₄ and 15-25 to ethylene/H₂. These gas permeability measurements are believed to be the first of their kind with a PDMS Ag FTM. It is noted that ethylene has a 2 (or less) selectivity ratio over CO₂. While H₂ (and CO₂) can optionally be removed before performing the separation, the PDMS Ag FTM can withstand some H₂ exposure. H₂ can reduce silver from its active Ag⁺ ion to Ag metal which can cause the PDMS Ag FTM to fail upon long term H₂ exposure. Therefore, the concentration of H₂ in the feed stream (e.g., the electrolyzer feed stream) may be evaluated, and some or substantially all of the H₂ may be controlled (e.g., removed) from the feed stream prior to performing the separation with the PDMS Ag FTM.

Returning to FIG. 8 and FIG. 9, the gas permeability experiments were repeated on a comparative membrane that was comparable to the PDMS Ag FTM according to embodiments of the disclosure with the exception that the comparative membrane did not contain titania in the hydrophobic polymer and ceramic layer of the membrane. Gas permeabilities of ethylene (FIG. 8) and H₂ (FIG. 9) on the comparative Ag FTM and on the PDMS Ag FTM in accordance with embodiments of the disclosure were evaluated over 48 hours of exposure to the same gas stream comprising 50 vol % H₂, 36.5 vol % He, 2.5 vol % CH₄, 5 vol % CO₂, and 5 vol % C₂H₄. Results show that the comparative membrane exhibited gas permeability and selectivity ratios of ethylene showing significant losses in ethylene transport after 2 days, and an increase of H₂ permeation after 48 hours on the comparative membrane. The gas permeability measurements show that titania is advantageous in the PDMS Ag FTM for gas transport, especially in a reducing atmosphere. The same gas mixture with H₂ will reduce the PDMS Ag FTM faster without titania present in the membrane, where ethylene transport diminishes after 3 days and its selectivity is lost.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A separation membrane comprising:
a polymer layer;
a metal salt layer adjacent to the polymer layer;
a hydrophobic polymer-ceramic layer adjacent to the metal salt layer; and
a porous support layer adjacent to the hydrophobic polymer-ceramic layer.

2. The separation membrane of claim 1, wherein the polymer layer comprises one or more of polydimethylsiloxane, polyimide, acrylic, epoxy, polyethylene, polystyrene, polyvinylchloride, polytetrafluorethylene, polyester, and polyurethane.

3. The separation membrane of claim 1, wherein the metal salt layer comprises a filter impregnated with a metal salt solution.

4. The separation membrane of claim 3, wherein the metal salt solution comprises a room temperature ionic liquid.

5. The separation membrane of claim 3, wherein the metal salt solution comprises a metal cation comprising one or more of copper, silver, gold, cadmium, mercury, bismuth, titanium, tin, and lead and a salt anion comprising one or more of iodide (I⁻), bisulfide (SH⁻), cyanide (CN⁻), thiocyanide (SCN⁻), nitrate (NO₃⁻), nitride (N₃⁻), tetrafluoroborate (BF₄⁻), tetraphenylborate (B(C₆H₅)₄⁻), triflate (CF₃SO₃⁻), bistriflimide ((CF₃SO₂)₂N⁻), and sulfide (S₂⁻).

6. The separation membrane of claim 1, wherein the metal salt layer comprises a glass fiber filter impregnated with a metal salt solution.

7. The separation membrane of claim 1, wherein the metal salt layer comprises a filter impregnated with an aqueous silver salt solution.

8. The separation membrane of claim 1, wherein the hydrophobic polymer of the hydrophobic polymer-ceramic layer comprises one or more of an acrylic, an epoxy, a polyethylene, a polystyrene, polyvinylchloride, polytetrafluorethylene, polydimethylsiloxane, a polyester, and a polyurethane.

9. The separation membrane of claim 1, wherein the hydrophobic polymer-ceramic layer comprises an oxide ceramic, a metal organic framework (MOF), or a molecular sieve.

10. The separation membrane of claim 1, wherein the hydrophobic polymer-ceramic layer comprises one or more of titanium (III) oxide and blue-colored titanium dioxide.

11. The separation membrane of claim 1, wherein the hydrophobic polymer-ceramic layer comprises a hydrophobic polymer and titanium (III) oxide.

12. The separation membrane of claim 1, wherein the hydrophobic polymer-ceramic layer comprises polydimethylsiloxane and reduced titanium dioxide.

13. The separation membrane of claim 1, wherein the porous support layer comprises one or more of polyether sulfone, polyacrylonitrile, and polyvinylidene fluoride.

14. The separation membrane of claim 1, further comprising:
a stainless steel disk disposed between the porous support layer and the hydrophobic polymer-ceramic layer, the hydrophobic polymer-ceramic layer coated on the stainless steel disk on a side adjacent to the metal salt layer.

15. A facilitated transport separation membrane comprising:
a polymer layer comprising one or more of polydimethylsiloxane, polyimide, acrylic, epoxy, polyethylene, polystyrene, polyvinylchloride, polytetrafluorethylene, polyester, and polyurethane;
a metal salt layer comprising a filter impregnated with an aqueous silver salt solution, the metal salt layer adjacent to the polymer layer;
a hydrophobic polymer-ceramic layer adjacent to the metal salt layer, the hydrophobic polymer-ceramic layer comprising polydimethylsiloxane and titanium (III) oxide; and
a porous support layer adjacent to the hydrophobic polymer-ceramic layer.

16. A method for separating components in a feed stream, the method comprising:
providing a separation membrane comprising a membrane stack assembly having a feed stream side and a permeate side, the membrane stack assembly comprising:
a polymer layer;
a metal salt layer adjacent to the polymer layer;
a hydrophobic polymer-ceramic layer adjacent to the metal salt layer; and
a porous support layer adjacent to the hydrophobic polymer-ceramic layer;
passing a feed stream comprising one or more olefins and paraffins across the feed stream side of the separation membrane;
providing a driving force for transmembrane permeation of the feed stream; and
withdrawing from the permeate side a permeate enriched in one or more alkenes relative to the feed stream.

17. The method of claim 16, wherein passing a feed stream across the feed stream side comprises passing the feed stream comprising a gas mixture of two or more components across the feed stream side.

18. The method of claim 16, wherein passing a feed stream across the feed stream side comprises passing the feed stream comprising a gas mixture of one or more alkenes and one or more alkanes across the feed stream side.

19. The method of claim 16, wherein passing a feed stream across the feed stream side comprises passing the feed stream comprising a mixture of two or more of hydrogen, nitrogen, carbon monoxide, carbon dioxide, ethylene, ethane, methane, water, water vapor, and helium across the feed stream side.

20. The method of claim 16, wherein passing a feed stream across the feed stream side comprises passing the feed stream comprising a mixture of two or more of hydrogen, nitrogen, carbon monoxide, carbon dioxide, ethylene, ethane, methane, water, water vapor, and helium and wherein withdrawing from the permeate side a permeate comprises withdrawing the permeate comprising ethylene.
